(19) United States
(12) Patent Application Publication
(10) Pub. No.: US 2026/0357740 A1
(43) Pub. Date: Nov. 12, 2026

(54) SYSTEM AND METHOD FOR HYDROGEN ENRICHED PRE-CHAMBER IGNITION AMMONIA COMBUSTION

(71) Applicant: THE RESEARCH FOUNDATION FOR THE STATE UNIVERSITY OF NEW YORK, Albany, NY (US)

(72) Inventor: Dimitris Assanis, Stony Brook, NY (US)

(21) Appl. No.: 19/118,456

(22) PCT Filed: Oct. 4, 2023
(86) PCT No.: PCT/US2023/034482

§ 371 Date: Apr. 4, 2025

Related U.S. Application Data
(60) Provisional application No. 63/378,341, filed on Oct. 4, 2022.

(51) Int. Cl. F02B 19/10; F01N 5/02; F02B 19/12; F02B 19/18; F02D 19/06; F02M 31/16

(52) U.S. Cl. CPC F02B 19/108; F01N 5/02; F02B 19/12; F02B 19/18; F02D 19/0649; F02M 31/16

(57) ABSTRACT

A system and method are provided for hydrogen enriched pre-chamber ignition ammonia combustion in an internal combustion engine. The system and method implement H2-enriched ammonia combustion by combining on-board ammonia cracking with exhaust heat recovery and/or turbulent jet ignition, to a practical approach to reduce greenhouse gas (GHG) emissions for off-road vehicles.

### FIELD

The disclosure is directed to combustion engines, and more particularly to combustion engines adapted to be powered by clean energy sources for reducing greenhouse gas (GHG) emissions.

### BACKGROUND

Internal combustion engines for powering automobiles, ships, airplanes, trains, and a variety of other powered devices are well known. Typically, internal combustion engines use fossil fuels such as gasoline and diesel to power the engine. Fossil fuels are a nonrenewable resource that when burnt emit carbon dioxide (GHG) and pollute the environment. As such, there is a desire to move away from the use of fossil fuels towards cleaner more environmentally friendly energy sources.

Environmentally friendly energy sources are known but due to their chemical properties are currently not a practical replacement for fossil fuels. One such environmentally friendly energy source is hydrogen. However, hydrogen is a particularly challenging product to transport and store because of its energy density and wide flammability range. To store hydrogen, e.g., in a fuel tank of a vehicle, the hydrogen must be stored at high pressures or at very low temperatures.

Attempts have been made to use industrial chemicals such as ammonia (NH3) as an energy carrier to provide an environmentally friendly energy source. Ammonia is an attractive energy carrier with potential to speed up the transition to a clean energy economy and one of the most promising low-carbon fuels to decarbonize hard-to-electrify applications of the transportation sector. Some of the benefits of ammonia include a low carbon intensity and competitive cost of approximately 90% lower carbon intensity than petroleum fuels and $3.0/gal-diesel-eq. for ammonia obtained from water electrolysis plus Haber-Bosch processing. Ammonia has a well-established industry with high production capacity (global more than 235MT/year) and is widely available. Moreover, ammonia also has a higher volumetric energy density than that of hydrogen (H2) and batteries, and like that of ethanol/methanol. Unlike other H2-based propulsion technologies that will be slow to displace liquid fuels due to challenges such as on-vehicle storage, durability, lack of infrastructure and high cost, ammonia can be easily stored on board (liquid at 25 °C & ~10 bar). Thus, ammonia can be rapidly deployed as an efficient hydrogen carrier and can have an immediate impact on GHG emissions for off-road and non-road machinery.

However, ammonia combustion shows several technical barriers that must be addressed before widespread implementation. Ammonia shows high autoignition resistance, which makes mixing-controlled ammonia combustion in compression-ignition engines, such as those used in most off-road applications, impractical. Solutions to this problem include dual-fuel ammonia-diesel combustion, but two fuel systems are required and the net GHG emissions are still high if using petroleum diesel. Ammonia has impractically low burning rates in both spark-ignition and compression-ignition engines due to a low flame speed. Several investigations showed that doping ammonia with H2 can resolve this problem. However, this requires an additional integration of dedicated H2 storage and re-supply into the final vehicle platform.

On-board ammonia cracking using exhaust heat recovery is a viable solution to generate a consistent stream of H2-enriched ammonia without requiring a complex and expensive H2 fuel system. However, on-demand H2 production can be challenging at some operating conditions such as at low engine loads. Turbulent jet ignition has previously demonstrated the ability to significantly enhance the burning rate of premixed fossil-fuel based combustion, thus this could reduce the H2 quantity required to enhance the ignition and flame speeds of ammonia for combustion applications.

Even with the existence of on-board cracking and turbulent jet ignition, further improvements are necessary before ammonia and other environmentally friendly energy sources can be a realistic replacement for fossil fuels. A continuing need exists for a system and method for adapting internal combustion engines for use with environmentally friendly energy sources.

### SUMMARY

This disclosure is directed to a system and method for hydrogen enriched pre-chamber ignition ammonia combustion. As described herein, the system and method implements H2-enriched ammonia combustion by combining on-board ammonia cracking with exhaust heat recovery and/or turbulent jet ignition, providing a practical approach to reduce greenhouse gas (GHG) emissions for off-road vehicles.

Aspects of the disclosure are directed to an internal combustion engine including an engine block defining at least one piston cylinder, a piston, a cylinder head, a pre-combustion chamber defining a pre-combustion chamber volume, a spark plug, a fuel injector, a parent fuel supply, and a partially decomposed intermediate chemical species fuel supply (hereinafter “intermediate fuel”). The piston is received within the at least one piston cylinder and is movable in reciprocating fashion. The cylinder head encloses the piston cylinder. The at least one piston cylinder and the piston define a main combustion chamber, and the cylinder head defines a cavity. The pre-combustion chamber is received within the cavity of the cylinder head and defines a pre-combustion chamber volume and orifices that connect the pre-combustion chamber volume to the main combustion chamber. The spark plug is supported on the cylinder head and is received within the pre-combustion chamber. The fuel injector is supported on the cylinder head and is positioned to inject the partially decomposed intermediate chemical species fuel (intermediate fuel) into the pre-combustion chamber volume. The parent fuel supply communicates with the main combustion chamber. The intermediate fuel supply communicates with the fuel injector to facilitate injection of the intermediate fuel into the pre-combustion chamber. The intermediate fuel supply can also communicate with the main combustion chamber. Ignition of the intermediate fuel within the pre-combustion chamber volume creates a flame that passes through the orifices of the pre-combustion chamber into the main combustion chamber to ignite the parent fuel and/or the intermediate fuel within the main combustion chamber.

In aspects of the disclosure, the parent fuel supply is selected from the group consisting of ammonia, or any other fuel molecule that can sustain an exothermic reaction during a combustion process and has a molecular composition that will allow for partial decomposition into intermediate species.

In some aspects of the disclosure, the intermediate fuel supply is hydrogen or any partially decomposed chemical species that originated from the parent fuel.

In certain aspects of the disclosure, the at least one piston cylinder includes a plurality of piston cylinders.

In aspects of the disclosure, the internal combustion engine includes an intake manifold for directing the parent fuel to the main combustion chamber.

In some aspects of the disclosure, the intake manifold is connected to the at least one piston cylinder by intake runners.

In certain aspects of the disclosure, the internal combustion engine includes an exhaust manifold for directing exhaust gases away from the main combustion chamber.

In aspects of the disclosure, the internal combustion engine includes a cracker for decomposing the parent fuel and delivering the intermediate fuel to the fuel injector.

In some aspects of the disclosure, the cracker is coupled to the exhaust manifold to direct the exhaust gases to the cracker to provide heat to the cracker.

In certain aspects of the disclosure, the internal combustion engine includes an intermediate fuel supply line coupled to the intake manifold to enrich the parent fuel with the intermediate fuel.

Other aspects of the disclosure are directed to a method of operating an internal combustion engine that includes delivering a parent fuel to a main combustion chamber of an internal combustion engine, delivering an intermediate fuel to a pre-combustion chamber of the internal combustion engine, igniting the intermediate fuel within the pre-combustion chamber to create a large activation energy source such as a flame, and directing the flame and highly enthalpious species into the main combustion chamber to ignite the parent fuel or parent/intermediate species blended fuel within the main combustion chamber.

In aspects of the disclosure, the method includes decomposing the parent fuel to create a supply of the intermediate fuel.,

In some aspects of the disclosure, decomposing the parent fuel includes passing the parent fuel through a cracker.

In certain aspects of the disclosure, delivering the parent fuel to the main combustion chamber of the internal combustion engine includes delivering ammonia to the main combustion chamber of the internal combustion engine.

In aspects of the disclosure, delivering the intermediate fuel to the pre-combustion chamber of the internal combustion engine includes delivering hydrogen to the pre-combustion chamber of the internal combustion engine.

In some aspects of the disclosure, the method includes mixing the intermediate fuel with the parent fuel to increase the reactivity of the parent fuel.

### BRIEF DESCRIPTION OF THE DRAWINGS

Various aspects of the disclosed internal combustion engine and methods of use are described herein below with reference to the drawings, wherein:

FIG. 1 is a schematic view of an internal combustion engine according to aspects of the disclosure;

FIG. 2 is a cross-sectional view taken through one cylinder of the internal combustion engine shown in FIG. 1; and

FIG. 2A is an enlarged view of the indicated area of detail shown in FIG. 2.

### DETAILED DESCRIPTION OF THE INVENTION

The following detailed description of embodiments of the invention will be made in reference to the accompanying drawings. In describing the invention, explanation about related functions or constructions known in the art are omitted for the sake of clearness in understanding the concept of the invention to avoid obscuring the invention with unnecessary detail. As used herein, the term “intermediate fuel” means a fuel that is produced by decomposing a parent fuel.

Embodiments of the invention described herein provide a system and method for hydrogen enriched pre-chamber ignition ammonia combustion. As described herein, the system and method implements H2-enriched ammonia combustion by combining on-board ammonia cracking with exhaust heat recovery and/or turbulent jet ignition, providing a practical approach to reduce greenhouse gas (GHG) emissions for on-road and off-road vehicles as well as stationary applications.

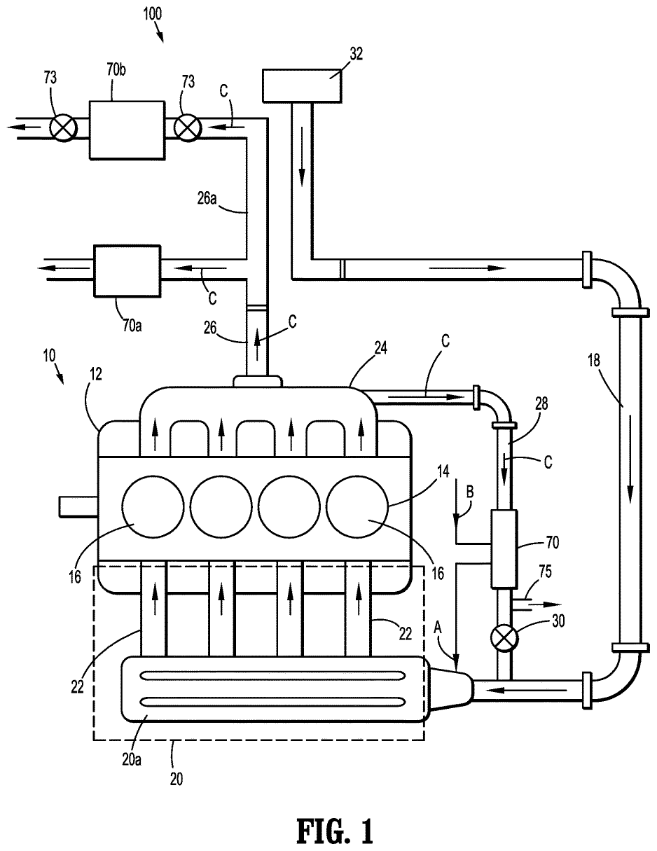

FIG. 1 illustrates an internal combustion engine according to aspects of the disclosure shown generally as internal combustion engine 10. The internal combustion 10 includes an engine block 12 that defines one or more piston cylinders 14, cylinder heads 16 positioned atop the piston cylinders 14, air intake path 18 that communicate with an intake manifold 20 which includes a plenum 20a and intake runners 22 that communicate with the piston cylinders 14, an exhaust manifold 24, an exhaust line 26 that communicates with the exhaust manifold 24, and an exhaust recirculation line 28. The air intake path 18 may include an intake air filter 32. The exhaust recirculation line 28 is connected to the air intake line 18 by a metering valve 30 to regulate the combustion mixture for load control or emission control as well as provide heat and/or assist to vaporize liquid fuel in the air intake line 18.

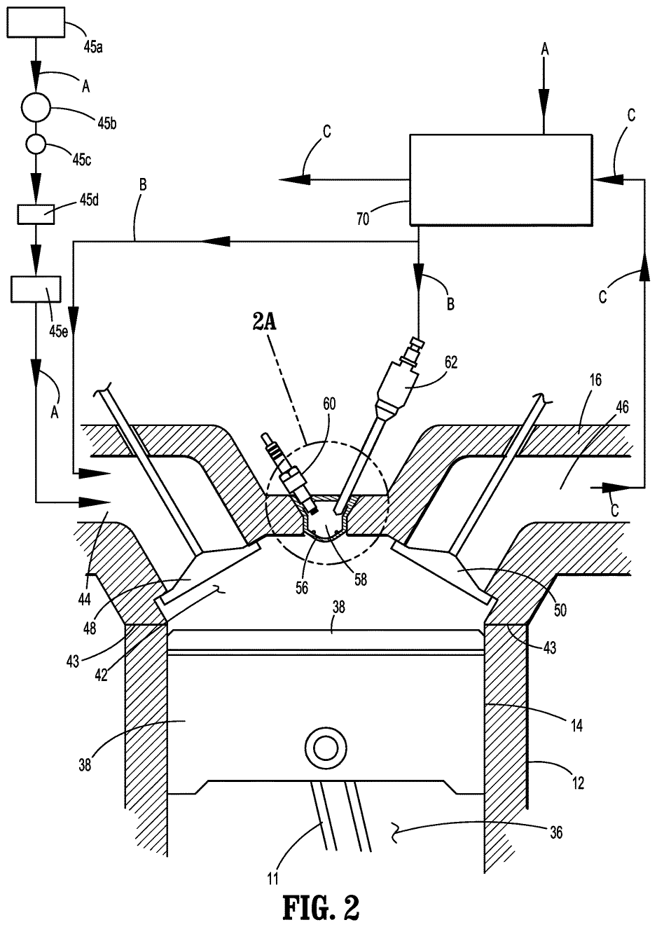

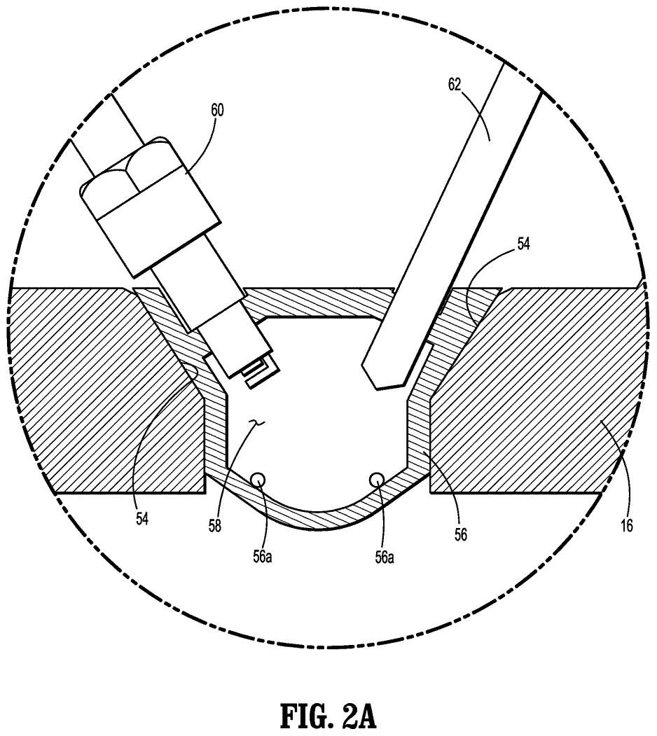

FIGS. 2 and 2A illustrate a piston cylinder 14 and cylinder head 16 of the internal combustion engine 10 shown in FIG. 1. The piston cylinder 14 defines a volume 42 that receives a piston 38 that is coupled to a crankshaft (not shown) by a connecting rod 11. The connecting rod 40 is positioned within a crank case volume 36 and is pivotably coupled to the crankshaft (not shown) and pivotably coupled to the piston 38 such that reciprocating movement of the piston 38 within the piston cylinder 14 rotates the crankshaft (not shown). The piston cylinder 14, the upper surface or crown of the piston 38, and the cylinder head 16 define a main combustion chamber volume 42. During a compression stroke, the crankshaft pushes the piston 38 within the piston cylinder 14, and during an expansion stroke, the piston 38 pushes/rotates the crankshaft.

The cylinder head 16 is supported on the engine block 12 on a head gasket 43 and defines a fuel/air intake channel 44 and an exhaust gas channel 46 that communicate with the main combustion chamber volume 42. The intake path 44 receives a parent fuel “A” (FIG. 2) from the fuel tank (not shown) and delivers the parent fuel “A” into the main combustion chamber volume 42. Where the parent fuel “A” is in a liquid state, the parent fuel “A” is delivered from a fuel tank 45a (FIG. 2) by a fuel pump 45b through a pressure regulator 45c, a fuel rail 45d, and a fuel injector 45e into the air intake path 44. Although not shown, where the parent fuel “A” is in compressed gaseous state, a pressure regulator 45c and a metered or controlled fuel supply orifice (not shown) can be provided to directly inject and atomize the parent fuel “A” within the main combustion chamber volume 42. The cylinder head 16 also supports an intake valve 48 and an exhaust valve 50. The intake valve 48 controls flow of air, the parent fuel “A”, and an intermediate fuel B (if present) into the main combustion chamber volume 42 and the exhaust valve 50 controls exhaust gas flow from the main combustion chamber volume 42. In systems not including a fuel injector for injecting the parent fuel “A” into the main combustion chamber volume 42, the heat of the intake valve 50 helps to atomize the parent fuel “A” as it is delivered to the main combustion chamber volume 42.

In aspects of the disclosure, the cylinder head 16 defines a cavity 54 that receives a pre-combustion chamber 56 that defines a pre-combustion chamber volume 58 (FIG. 2A). The pre-combustion chamber 56 defines at least one connecting orifice 56a to the main combustion chamber volume 42 and can be threaded and screwed into the cavity 54 of the cylinder head 16 or secured within the cavity 54 of the cylinder head 16 by other known fastening techniques, e.g., welding, compression fit, or be entirely formed as part of the cylinder head 16. The pre-combustion chamber 56 supports a spark plug 60 and a direct fuel injector 62 that communicate with the pre-combustion chamber volume 58. The spark plug 60 is positioned to ignite an intermediate fuel “B” of the parent fuel “A” within the pre-combustion chamber 58 to create a flame, and a chemical kinetic intermediate reaction species, and/or highly enthalpious flow fields that exit(s) the pre-combustion chamber volume 58 through the orifice(s) 56a to ignite the parent fuel “A” within the main combustion chamber volume 42. Highly enthalpious flow(s) including hot thermal mass and/or partially or fully burned mixture products are ejected into the main combustion chamber volume 42 to start the combustion of the parent fuel “A” and/or blend of parent fuel “A” with intermediate fuel B within the main chamber 42.

In aspects of the disclosure, the orifices 56a of the pre-combustion chamber 56 are configured in such a fashion to direct the highly enthalpious flow to a preferential region or multiple desired region(s) within the main combustion chamber volume 42. The penetration distance, speed, and angle of attack into the main combustion chamber volume 42 can be controlled by the number of orifice(s), location of the orifice(s), angle of the orifice(s) and shape factor/form of the connecting orifices.

In aspects of the disclosure, the parent fuel “A” is an environmentally friendly, non-fossil fuel such as ammonia, and the intermediate fuel “B” is hydrogen (H2) that is decomposed from the parent fuel “A”. In some aspects of the disclosure, the internal combustion engine 10 forms part of a system 100 (FIG. 1) that includes a thermal cracker 70 shown schematically in FIG. 2. The thermal cracker 70 is provided to decompose the parent fuel “A” which is less reactive to produce a more reactive intermediate fuel “B”. The thermal cracker 70 includes a reactor that may contain a catalyst. The parent fuel “A” is delivered to the reactor of the thermal cracker 70 and is heated by the exhaust gases “C” (FIG. 2) of the internal combustion engine 10. The exhaust gases “C” can exit the thermal cracker 70 through an exhaust line 75 which can be coupled to the exhaust line 26. When the parent fuel “A” passes over the catalyst in the reactor of the thermal cracker 70, the parent fuel “A” is decomposed to produce the intermediate fuel, i.e., hydrogen (H2), that is delivered to the injector 62 of the pre-combustion chamber 58. The more reactive intermediate fuel “B” is ignited in the pre-combustion chamber 58 to generate a flame that passes through the orifices 56a of the pre-combustion chamber 56 into the main combustion chamber volume 42 to ignite the less reactive parent fuel “A” within the main combustion chamber volume 42. In some aspects of the disclosure, the intermediate fuel “B” can be delivered to the fuel intake channel 44 to enrich the parent fuel “A” and make the parent fuel “A” more reactive.

The cracker 70 can be repositioned to multiple locations within the system 100. For example, the cracker 70a (FIG. 1) can be coupled to the engine exhaust line 26 such that all exhaust gas “C” flows through the cracker 70a. The cracker 70b can also be located on a bypass line 26a that extends from the engine exhaust line 26 through the cracker 70b. The exhaust line 26a can include one or more valves 73 to regulate the volume of exhaust gases “C” that travel through the cracker 70b. Although not stated specifically, the system 100 will include only one cracker (70, 70a, or 70b).

In some aspects of the disclosure, the internal combustion engine 10 can include two or more pre-combustion chambers 58 for each main combustion chamber volume 42. It is also envisioned that the aspects of this disclosure are suitable for use in single or multiple cylinder internal combustion engines. It is also envisioned that the aspects of this disclosure are suitable for use in different internal combustion reciprocating piston engine arrangements such as opposed piston arrangements, opposed piston opposed cylinder arrangements, rotary engine arrangements and others. Although the parent fuel is disclosed as being ammonia, it is envisioned that the parent fuel could include other chemicals including but not limited to heteroatomic, and hydrocarbon molecules such as methane, ethanol, gasoline, diesel, etc. It is also envisioned that the parent fuel “A” could include homoatomic molecules and the intermediate fuel “B” could be a derived stable or unstable species e.g., hydrogen proton, hydroxyl radical,.

While the invention has been shown and described with reference to certain aspects of the present disclosure, it will be understood by those skilled in the art that various changes in from and details may be made therein without departing from the spirit and scope of the present disclosure and equivalents thereof. Persons skilled in the art will understand that the devices and methods specifically described herein and illustrated in the accompanying drawings are non-limiting exemplary aspects of the disclosure. It is envisioned that the elements and features illustrated or described in connection with one exemplary embodiment may be combined with the elements and features of another without departing from the scope of the disclosure. Also, one skilled in the art will appreciate further features and advantages of the disclosure based on the above-described aspects of the disclosure. Accordingly, the disclosure is not to be limited by what has been particularly shown and described, except as indicated by the appended claims.

What is claimed is:

1. An internal combustion engine comprising:
an engine block defining at least one piston cylinder;
a piston received within the at least one piston cylinder, the piston movable in reciprocating fashion;
a cylinder head enclosing the piston cylinder, the at least one piston cylinder, and the piston defining a main combustion chamber volume, the cylinder head defining a cavity;
a pre-combustion chamber received within the cavity of the cylinder head, the pre-combustion chamber defining a pre-combustion chamber volume and at least one orifice that connects the pre-combustion chamber volume to the main combustion chamber volume;
a spark plug supported on the cylinder head and received on the pre-combustion chamber;
a fuel injector supported on the cylinder head and positioned to inject an intermediate fuel into the pre-combustion chamber volume;
a parent fuel supply communicating with the main combustion chamber volume; and
an intermediate fuel supply communicating with the fuel injector to facilitate injection of the intermediate fuel into the pre-combustion chamber volume, wherein ignition of the intermediate fuel within the pre-combustion chamber volume creates a flame and/or chemical kinetic intermediate reaction species, and/or highly enthalpious flow fields that exit(s) the pre-combustion chamber volume through the at least one orifice of the pre-combustion chamber into the main combustion chamber volume to ignite the parent fuel within the main combustion chamber volume.

2. The internal combustion engine of claim 1, wherein the parent fuel supply is selected from the group consisting of ammonia methane, ethanol, gasoline, and diesel.

3. The internal combustion engine of claim 2, wherein the intermediate fuel supply is hydrogen.

4. The internal combustion engine of claim 1, wherein the at least one piston cylinder includes a plurality of piston cylinders.

5. The internal combustion engine of claim 1, further including an intake manifold for directing the parent fuel into the main combustion chamber volume.

6. The internal combustion engine of claim 1, wherein the intake includes a plenum and runners that are connected to the at least one piston cylinder.

7. The internal combustion engine of claim 1, further including an exhaust manifold for directing exhaust gases away from the main combustion chamber.

8. The internal combustion engine of claim 3, further including a cracker for decomposing the parent fuel and delivering the intermediate fuel to the fuel injector.

9. The internal combustion engine of claim 8, wherein the cracker is coupled to the exhaust manifold to direct the exhaust gases to the cracker to provide heat to the cracker.

10. The internal combustion engine of claim 9, further including an intermediate fuel supply line coupled to the intake manifold to enrich the parent fuel with the intermediate fuel.

11. A method of operating an internal combustion engine comprising:
delivering a parent fuel to a main combustion chamber volume of an internal combustion engine;
delivering an intermediate fuel to a pre-combustion chamber volume of the internal combustion engine;
igniting the intermediate fuel within the pre-combustion chamber volume to create a flame; and
directing the flame into the main combustion chamber volume to ignite the parent fuel within the main combustion chamber volume.

12. The method of claim 11, further including decomposing the parent fuel to create a supply of the intermediate fuel.

13. The methos of claim 12, wherein decomposing the parent fuel includes passing the parent fuel through a cracker.

14. The method of claim 13, wherein delivering the parent fuel to the main combustion chamber volume of the internal combustion engine includes delivering ammonia to the main combustion chamber volume of the internal combustion engine.

15. The method of claim 14, wherein delivering the intermediate fuel to the pre-combustion chamber volume of the internal combustion engine includes delivering hydrogen to the pre-combustion chamber volume of the internal combustion engine.

16. The method of claim 13, further including mixing the intermediate fuel with the parent fuel to increase the reactivity of the parent fuel.
